(19) United States
(12) Patent Application Publication
(10) Pub. No.: US 2013/0162679 A1
(43) Pub. Date: Jun. 27, 2013

(54) APPARATUS AND METHOD FOR EMBODYING OVERLAY IMAGES USING MRLC

(71) Applicants: Gyu Won Kim, Gyunggi-do (KR); Joo Young Ha, Gyunggi-do (KR); In Taek Song, Gyunggi-do (KR)

(72) Inventors: Gyu Won Kim, Gyunggi-do (KR); Joo Young Ha, Gyunggi-do (KR); In Taek Song, Gyunggi-do (KR)

(73) Assignee: SAMSUNG ELECTRO-MECHANICS CO., LTD., Gyunggi-do (KR)

(21) Appl. No.: 13/409,017

(22) Filed: Feb. 29, 2012

(30) Foreign Application Priority Data
Dec. 27, 2011 (KR) 1020110143239

(51) Int. Cl. G09G 5/00

(52) U.S. Cl. 345/634

(57) ABSTRACT

Disclosed herein are an apparatus and a method for embodying overlay images using MRLC. The apparatus includes: a data encoder receiving static overlay images, warning overlay images, and continuous dynamic overlay images to perform RLC on each image and padding dummy data to perform MRLC on the padded dummy data and encode the padded dummy data; an address generator generating address indices; a memory the encoded MRLC data; a data decoder accessing the MRLC data of each overlay image; and a microcontroller calculating each RLC data size to obtain the maximum RLC data size and transmit the maximum RLC data size to the data encoder and reading the stored MRLC data and display each overlay image decoded. By this configuration, the low-price microcontroller can maximize the storage efficiency of the memory and implement the fast and easy access, thereby implementing the effective overlay and saving costs.

### CROSS REFERENCE TO RELATED APPLICATION

This application claims the benefit of Korean Patent Application No. 10-2011-0143239, filed on Dec. 27, 2011, entitled “Apparatus and Method for Embodying Overlay Images using MRLC”, which is hereby incorporated by reference in its entirety into this application.

### BACKGROUND OF THE INVENTION

1. Technical Field

The present invention relates to an apparatus and a method for embodying overlay images using MRLC.

2. Description of the Related Art

Generally, a configuration of a warning message, a static overlay, an dynamic overlay of a rear camera for an electrical apparatus has a type of reducing a data size of bit maps through run length coding (RLC) so as to minimize a memory and storing the data in a memory and reading the data from the memory according to address indices of each bit map stored in the memory using handle information input from a car and displaying the read data on a screen.

In this case, a start address and an end address of the address indices may be changed according to the data size of each stored bit map.

Therefore, when implementing the overlay images by reading the bit maps stored in the memory, a storage position of the start address and the end address of the address indices of each image is changed and thus, an access time for reading each overlay image from the memory is long. In particular, when implementing the dynamic overlay images changing in real time according to wheel steering of a vehicle at the time of parking, a cutting phenomenon may occur.

Further, a need exists for an apparatus and a method for implementing overlay images having a new configuration capable of more effectively configuring the static overlay images and the warning overlay images and the dynamic overlay image changing in real time and accurately matching image timing input from a full-length image apparatus and display timing of an on screen display (OSD).

### SUMMARY OF THE INVENTION

The present invention has been made in an effort to provide an apparatus and a method for embodying overlay images using MRLC capable of rapidly and easily implementing an access at the time of reading corresponding bit maps by uniformly matching a data size of a bit map image using the MRLC.

According to a preferred embodiment of the present invention, there is provided an apparatus for embodying overlay images using MRLC, including: a data encoder receiving static overlay images, warning overlay images, and continuous dynamic overlay images to perform RLC on each image and padding dummy data so as to have the same size as a maximum RLC data size to perform MRLC on the padded dummy data and encode the padded dummy data; an address generator generating address indices to be applied to each MRLC data encoded by the data encoder; a memory storing the encoded MRLC data according to the address indices generated by the address generator; a data decoder accessing the MRLC data of each overlay image stored in the memory according to the address indices to decode each MRLC data into original image data; and a microcontroller calculating each RLC data size encoded by the data encoder to obtain the maximum RLC data size and transmit the obtained maximum RLC data size to the data encoder and reading the stored MRLC data from the memory to perform a control to overlay and display each overlay image decoded by the data decoder.

The apparatus for embodying overlay images using MRLC may further include an image sensor inputting the static overlay images and the dynamic overlay images.

The apparatus for embodying overlay images using MRLC may further include a steering sensor sensing a steering angle of a vehicle wheel so as to input the continuous dynamic overlay images according to the steering of the vehicle wheel at the time of inputting the continuous dynamic overlay images.

The apparatus for embodying overlay images using MRLC may further include a display unit displaying the static overlay images, the warning overlay images, and the continuous dynamic overlay images that are overlaid by the control unit.

The memory may include: a flash memory storing the static overlay images, warning overlay images, and continuous dynamic overlay images encoded by the MRLC; and a plurality of buffers each accessing and reading the MRLC data of the static overlay images, the warning overlay images, and the continuous dynamic overlay images stored in the flash memory by the address indices at the time of reading so as to implement the overlay of each overlay image and temporarily storing the images, respectively.

The address indices of the address generator may be generated by the following [Equation 1] and [Equation 29 :

Start address index of N-th overlay image=(N-1)-th MRLC data size+1 [Equation 1]

End address index of N-th overlay image=(N-1)-th MRLC data size*N [Equation 2]

where N is an integer number.

According to a preferred embodiment of the present invention, there is provided a method for embodying overlay images using MRLC, including: (A) receiving static overlay images, warning overlay images, and continuous dynamic overlay images to perform RLC on each image and padding dummy data so as to have the same size as a maximum RLC data size to perform MRLC on the padded dummy data and encode the padded dummy data; (B) generating address indices to be applied to each encoded MRLC data so as to be stored in a memory; (C) accessing and decoding the MRLC data of the static overlay images, the warning overlay images, and the continuous dynamic overlay images stored in the memory by the address indices; and (D) overlaying and displaying each decoded overlay image.

Step (A) may include: (A1) receiving the static overlay images, the warning overlay images, and the continuous dynamic overlay images; (A2) performing RLC on the input static overlay images, warning overlay images, and continuous dynamic overlay images, respectively, to primarily encoding the images into each RLC data; (A3) calculating and comparing the RLC data sizes of the static overlay images, the warning overlay images, and the continuous dynamic overlay images encoded into the RLC data to obtain a maximum RLC data size; and (A4) padding dummy data in each RLC data so as to have the same RLC data size as the maximum RLC data size and performing MRLC on the dummy data so as to secondarily encoding the dummy data into each MRLC data.

In step (B), each address index corresponding to each overlay image encoded into each MRLC data may be generated so as to be stored in a flash memory of the memory, each address index being generated by the following [Equation 1] and [Equation 2]:

Start address index of N-th overlay image=(N-1)-th MRLCed data size+1 [Equation 1]

End address index of N-th overlay image=(N-1)-th MRLCed data size*N [Equation 2]

where N is an integer number.

Step (C) may include: (C1) accessing the MRLC data of the static overlay images, the warning overlay images, and the continuous dynamic overlay images stored in the memory by the address indices so as to be temporarily stored in each of the plurality of buffers; and (C2) reading and decoding each MRLC data of the static overlay images, the warning overlay images, and the continuous dynamic overlay images temporarily stored in each of the plurality of buffers.

Step (D) may include: (D1) blending the decoded static overlay images, warning overlay images, and continuous dynamic overlay images, respectively; (D2) overlaying and combining the blended static overlay images, warning overlay images, and continuous dynamic overlay images, respectively; and (D3) displaying the overlaid and combined images on a display unit.

### BRIEF DESCRIPTION OF THE DRAWINGS

FIG. 1 is a block diagram of an apparatus for embodying overlay images using MRLC according to a preferred embodiment of the present invention;

FIG. 2A is a diagram showing an example of static overlay images according to the preferred embodiment of the present invention;

FIG. 2B is a diagram showing an example of dynamic overlay images according to the preferred embodiment of the present invention;

FIG. 2C is a diagram showing an example of a displayed screen on which a static overlay image, a dynamic overlay image, and a warning overlay image according to the preferred embodiment of the present invention overlay one another to be displayed;

FIGS. 3A and 3B are diagrams showing storage representation and screen representation of a memory in which the dynamic overlay images shown in FIG. 2B are stored;

FIG. 4 is a flow chart showing a method for embodying overlay images using MRLC according to the preferred embodiment of the present invention; and

FIG. 5 is a detailed flow chart showing MRLC encoding and storing processes shown in FIG. 4.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

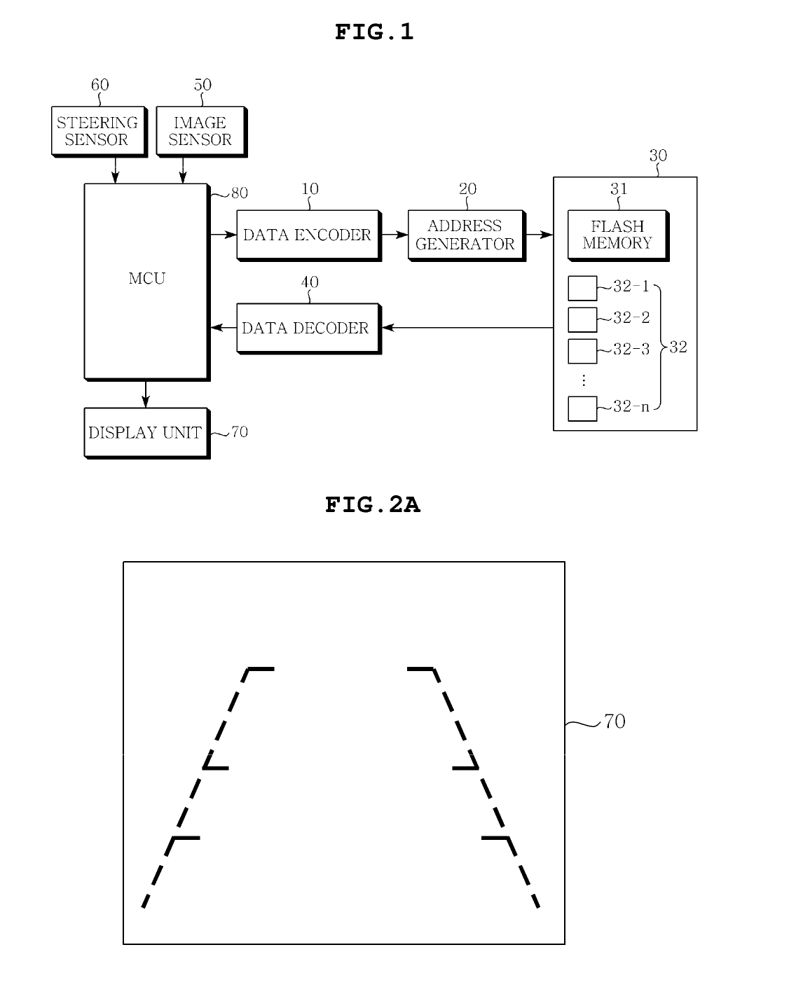

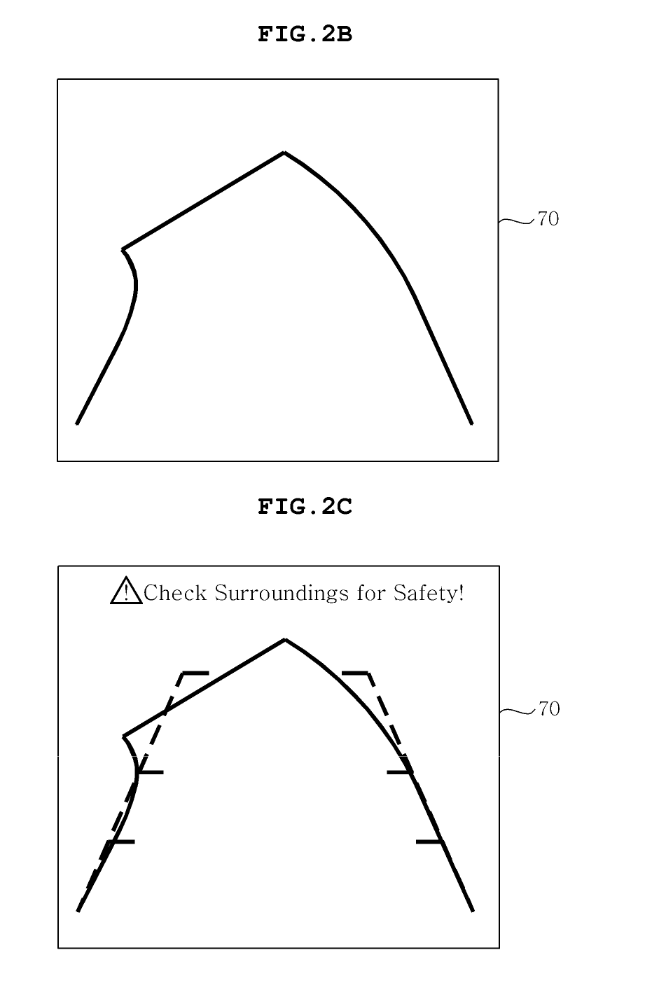

FIG. 1 is a block diagram of an apparatus for embodying overlay images using MRLC according to a preferred embodiment of the present invention, FIG. 2A is a diagram showing an example of static overlay images according to the preferred embodiment of the present invention, FIG. 2B is a diagram showing an example of dynamic overlay images according to the preferred embodiment of the present invention, and FIG. 2C is a diagram showing an example of a displayed screen on which a static overlay image, a dynamic overlay image, and a warning overlay image according to the preferred embodiment of the present invention overlay one another to be displayed.

Referring to FIG. 1, an apparatus for embodying overlay images using MRLC according to a preferred embodiment of the present invention is configured to include a data encoder 10, an address generator 20, a data decoder 40, a memory 30, an image sensor 50, a steering sensor 60, a display unit 70, and a microcontroller (MCU) 80.

The image sensor 50 is mounted at a rear of a vehicle to image a parking line of a rear of a car, or the like, at the time of parking, thereby generating and inputting static overlay images as shown in FIG. 2A.

The steering sensor 60 senses a steering angle of the vehicle wheels so as to input continuous dynamic overlay images according to the steering of the vehicle wheels at the time of inputting the continuous dynamic overlay images shown in FIG. 2B.

The data encoder 10 receives a plurality of overlay images (for example, warning message, static overlay images, and dynamic overlay images) as shown in FIGS. 2A to 2C to perform RLC on each image, thereby padding dummy data so as to have the same data size as the maximum RLC data size and encoding the dummy data with modified run length coding (hereinafter, referred to as ‘MRLC’).

In detail, the data encoder 10 performs primary encoding so as to perform the run length coding (RLC) on each input overlay image.

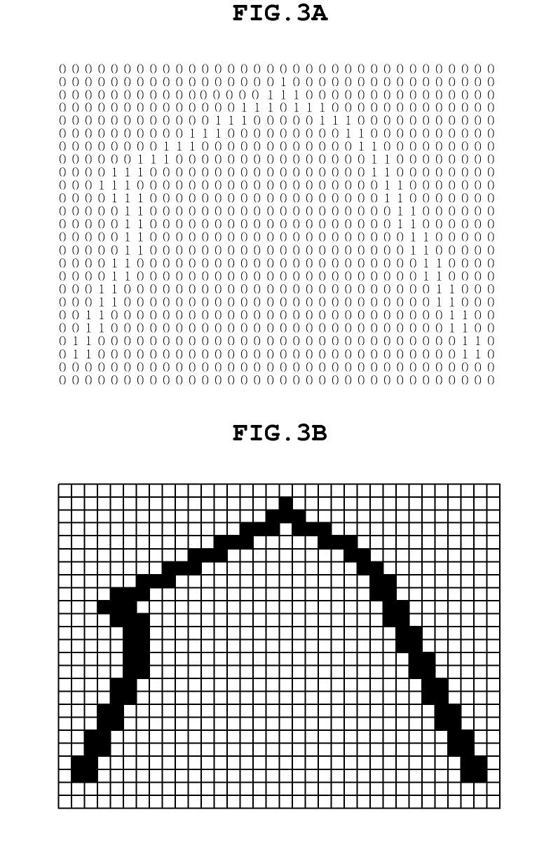

For example, when reviewing binary memory storage representation and screen representation of a binary image of the dynamic overlay shown in FIGS. 3A and 3B, a binary value of a second column of the binary image of the dynamic overlay becomes ‘0000000100000000’.

When the binary value of the second column is encoded into the RLC data to be represented, ‘0’ is seven, ‘1’ is one, and ‘0’ is again eight from the left and therefore, the second column binary value may be represented by ‘7W1B8W’. Herein, white (W) represents 0 and black (B) represents 1.

As described above, in order to represent the binary value of the second column, 16 bits are needed, while the binary value of the second column may be compressed to 6 bits when the RLC encoding is performed.

Similarly, when reviewing a binary value of a third column in the binary image of the dynamic overlay, the binary value becomes ‘0000001010000000’. When the binary value is encoded into the RLC data to be represented, 0 is six, 1 is one, 0 is one, 1 is one, and 0 is again seven from the left and therefore, may be represented by ‘6W1B1W1B7W’.

In this case, when comparing the RLC data size of the second column with the RLC data size of the third column, the RLC data of the second column may be compressed to 6 bits, while the RLC data of the third column may be compressed to 10 bits.

Then, the microcontroller (MCU) 80 calculates each RLC data size encoded from the data encoder 10 and compares each calculated RLC data size to obtain the maximum RLC data size and again transmit the obtained maximum RLC data to the data encoder 10.

Then, the data encoder 10 performs the primary encoding by padding the meaningless dummy data (for example, ‘0’ or ‘F’) and performing MRLC on the dummy data so that each RLC data size is the same as the maximum RLC data size transmitted from the microcontroller (MCU) 80.

For example, when the maximum RLC data size is 12 bits, the RLC data ‘7W1B8W’ of the second column are encoded into the MRLC data of ‘7W1B8W000000’ or ‘7W1B8WFFFFFF’.

Here, the dummy data ‘0’ is the meaningless dummy data differentiated from the binary number ‘0’.

Then, each RLC data are encoded into all the same MRLC data, all of which the size is the same, by the data encoder 10.

As described above, when performing the MRLC and the encoding by the data encoder 10, each MRLC data size is the same to easily determine the positions of the start address and the end address at the time of storing each MRLC data in the memory 30, thereby facilitating the access.

As described above, the address generator 20 generates the address indices to be applied to each MRLC data encoded by the data encoder 10.

In detail, the address generator 20 has each MRLC data all of which the size is the same. For example, when the start address of overlay image 1 is 0 and the end address thereof is the MRLC data size, the start address of overlay image 2 is the MRLC data size+1 of the overlay image 1 and the end address thereof is the MRLC data size×2 of the overlay image 1.

When this is represented by Equations, the positions of the start address and the end address of overlay image N are as follows.

Start address index of N-th overlay image=(N-1)-th MRLC data size+1 [Equation 1]

End address index of N-th overlay image=(N-1)-th MRLC data size*N [Equation 2]

Herein, N is an integer number.

The memory 30 stores the encoded MRLC data according to the address indices (that is, the start address index and the end address index calculated by the above [Equation 1] and [Equation 2]) generated by the address generator 20.

The memory 30 is configured to include a flash memory 30 storing the static overlay images, warning overlay images, and continuous dynamic overlay images encoded by the MRLC and a plurality of buffers 32 each accessing, reading, and temporarily storing the MRLC data of the overlay images, the warning overlay images, and the continuous dynamic overlay images stored in the flash memory 30 at the time of reading to implement the overlay of each overlay image.

In particular, the plurality of buffers 32 allows the dynamic overlay images to recognize the direction according to the wheel steering of the vehicle and reads and stores the MRLC data of the image in the corresponding period, thereby implementing the dynamic overlay images changing in real time without causing the cutting effect.

The data decoder 40 accesses the MRLC data of each overlay image stored in the memory 30 according to the address indices to decode each MRLC data into the original image data.

The display unit 70 displays on the screen the image in which each overlay image, that is, the static overlay images, the warning overlay images, and the continuous dynamic overlay images overlay one another by the control of the micro controller (MCU) 80.

The microcontroller (MCU) 80 generally controls the apparatus for embodying using the MRLC according to the preferred embodiment of the present invention.

More specifically, as described above, the microcontroller (MCU) 80 calculates each RLC data size encoded by the data encoder 10 to obtain the maximum RLC size and transmit the obtained maximum RLC size to the data encoder 10.

Then, the microcontroller (MCU) 80 reads the stored MRLC data from the memory 30 to perform a control to overlay and display each overlay image decoded by the data decoder 40.

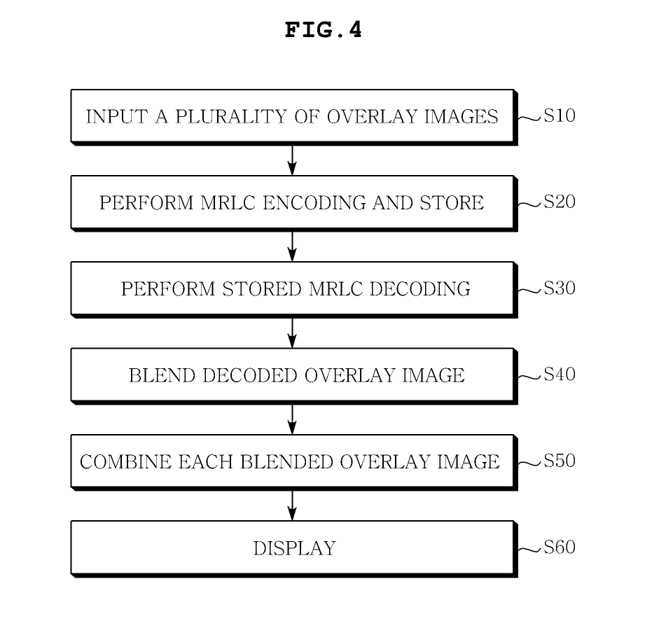

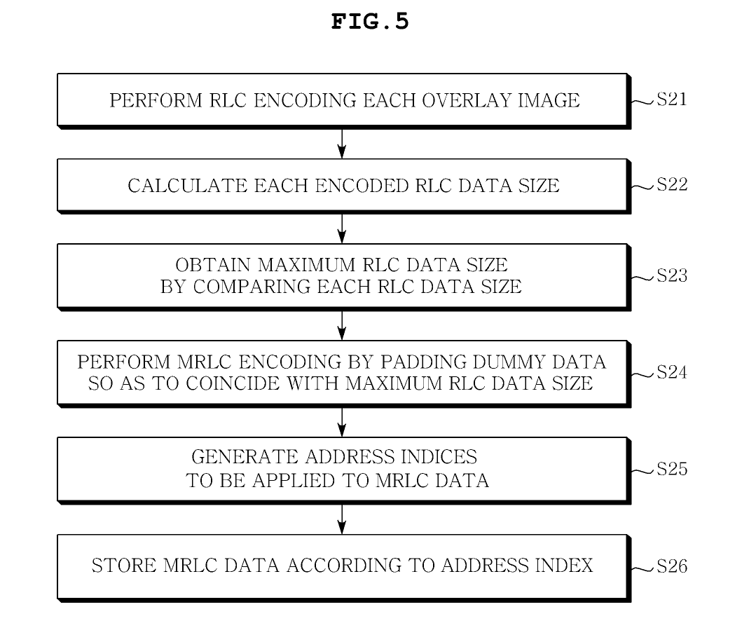

The operation of the microcontroller (MCU) 80 will be described with reference to FIGS. 4 and 5.

FIG. 4 is a block diagram showing a method for embodying overlay images using MRLC according to the preferred embodiment of the present invention and FIG. 5 is a detailed flow chart showing MRLC encoding and storing processes shown in FIG. 4.

Referring to FIGS. 4 and 5, in the method for embodying overlay images using MRLC, the microcontroller (MCU) 80 controls the data encoder 10 to receive the plurality of overlay images (for example, the static overlay images, the warning overlay images, and the continuous dynamic overlay images) (S10) and performs RLC on each image to pad the dummy data so as to have the same data size as the maximum RLC data size and MRLC, encode, and store the padded dummy data (S20).

In this case, each encoded MRLC data is stored in the memory 30 by generating the address indices from the address generator 20.

More specifically, as shown in FIG. 5, at S20, the microcontroller (MCU) 80 controls the data decoder 40 to perform RLC on the static overlay images, the warning overlay images, and the continuous dynamic overlay images and primarily encode them into each RLC data.

Further, the microcontroller (MCU) 80 receives each RLC data of the static overlay images, the warning overlay images, and the continuous dynamic overlay images encoded into the RLC data to calculate the size of each RLC data (S22) and compares each calculated RLC data size to obtain the maximum RLC data size (S23).

Next, the microcontroller (MCU) 80 transmits the maximum RLC data size to the data encoder 10 and controls the data encoder 10 to pad the meaningless dummy data (for example, 0 or F) so as to be equal to the maximum RLC data size and secondarily encode the padded dummy data into the MRLC data (S24).

Then, the address indices (that is, the start address index and the end address index) to be applied to each encoded MRLC data is generated (S25).

In this case, the address indices are generated by the following [Equation 1] and [Equation 2] since each MRLC data size is the same:

Start address index of N-th overlay image=(N-1)-th MRLC data size+1 [Equation 1]

End address index of N-th overlay image=(N-1)-th MRLC data size*N [Equation 2]

Herein, N is an integer number.

Then, each MRLC data of the static overlay images, the warning overlay images, and the continuous dynamic overlay images is stored in the memory 30 according to each address index (S26).

As described above, in order to overlay and display the static overlay images, the warning overlay images, and the continuous dynamic overlay images stored in the memory 30, the microcontroller (MCU) 80 controls the data decoder 40 to access the MRLC data of the static overlay images, the warning overlay images, and the continuous dynamic overlay images stored in the memory 30 by the address indices and decode the MRLC data into each original overlay image (S30).

Thereafter, the microcontroller (MCU) 80 blends the decoded static overlay images, warning overlay images, and continuous dynamic overlay images, respectively (S40), combines each blended overlay image, warning overlay image, and continuous dynamic overlay image (S50), and displays the combined images on the display unit (S60).

The preferred embodiments of the present invention can reduce the data size of the overlay images using the MRLC to maximize the storage efficiency of the memory and implement the fast and easy access at the time of reading the overlay images stored in the memory to prevent the cutting phenomenon at the time of implementing the dynamic overlay changing in real time, thereby implementing the more efficient overlay.

Further, the preferred embodiments of the present invention do not need to store the positional information of the address indices of each overlay image stored in the memory in the separate look-up table and use a small amount of internal memory space to allow the low-price micro controller to efficiently implement the overlay image, thereby reducing the costs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An apparatus for embodying overlay images using MRLC, comprising:
a data encoder receiving static overlay images, warning overlay images, and continuous dynamic overlay images to perform RLC on each image and padding dummy data so as to have the same size as a maximum RLC data size to perform MRLC on the padded dummy data and encode the padded dummy data;
an address generator generating address indices to be applied to each MRLC data encoded by the data encoder;
a memory storing the encoded MRLC data according to the address indices generated by the address generator;
a data decoder accessing the MRLC data of each overlay image stored in the memory according to the address indices to decode each MRLC data into original image data; and
a microcontroller calculating each RLC data size encoded by the data encoder to obtain the maximum RLC data size and transmit the obtained maximum RLC data size to the data encoder and reading the stored MRLC data from the memory to perform a control to overlay and display each overlay image decoded by the data decoder.

2. The apparatus as set forth in claim 1, further comprising an image sensor inputting the static overlay images and the continuous dynamic overlay images.

3. The apparatus as set forth in claim 1, further comprising a steering sensor sensing a steering angle of a vehicle wheel so as to input the continuous dynamic overlay images according to the steering of the vehicle wheel at the time of inputting the continuous dynamic overlay images.

4. The apparatus as set forth in claim 1, further comprising a display unit displaying the static overlay images, the warning overlay images, and the continuous dynamic overlay images that are overlaid by the control unit.

5. The apparatus as set forth in claim 1, wherein the memory includes:
a flash memory storing the static overlay images, the warning overlay images, and the continuous dynamic overlay images encoded by the MRLC; and
a plurality of buffers each accessing and reading the MRLC data of the static overlay images, the warning overlay images, and the continuous dynamic overlay images stored in the flash memory by the address indices at the time of reading so as to implement the overlay of each overlay image and temporarily storing the images, respectively.

6. The apparatus as set forth in claim 1, wherein the address indices of the address generator are generated by the following [Equation 1] and [Equation 2]:
Start address index of N-th overlay image=(N-1)-th MRLC data size+1 [Equation 1]
End address index of N-th overlay image=(N-1)-th MRLC data size*N [Equation 2]
where N is an integer number.

7. A method for embodying overlay images using MRLC, comprising:
(A) receiving static overlay images, warning overlay images, and continuous dynamic overlay images to perform RLC on each image and padding dummy data so as to have the same size as a maximum RLC data size to perform MRLC on the padded dummy data and encode the padded dummy data;
(B) generating address indices to be applied to each encoded MRLC data so as to be stored in a memory;
(C) accessing and decoding the MRLC data of the static overlay images, the warning overlay images, and the continuous dynamic overlay images stored in the memory by the address indices; and
(D) overlaying and displaying each decoded overlay image.

8. The method as set forth in claim 7, wherein step (A) includes:
(A1) receiving the static overlay images, the warning overlay images, and the continuous dynamic overlay images;
(A2) performing RLC on the input static overlay images, warning overlay images, and continuous dynamic overlay images, respectively, to primarily encoding the images into each RLC data;
(A3) calculating and comparing the RLC data sizes of the static overlay images, the warning overlay images, and the continuous dynamic overlay images encoded into the RLC data to obtain a maximum RLC data size; and
(A4) padding dummy data in each RLC data so as to have the same RLC data size as the maximum RLC data size and performing MRLC on the dummy data so as to secondarily encoding the dummy data into each MRLC data.

9. The method as set forth in claim 7, wherein in step (B), each address index corresponding to each overlay image encoded into each MRLC data is generated so as to be stored in a flash memory of the memory, each address index being generated by the following [Equation 1] and [Equation 2]:
Start address index of N-th overlay image=(N-1)-th MRLCed data size+1 [Equation 1]
End address index of N-th overlay image=(N-1)-th MRLCed data size*N [Equation 2]
Where N is an integer number.

10. The method as set forth in claim 7, wherein step (C) includes:
(C1) accessing the MRLC data of the static overlay images, the warning overlay images, and the continuous dynamic overlay images stored in the memory by the address indices so as to be temporarily stored in each of the plurality of buffers; and
(C2) reading and decoding each MRLC data of the static overlay images, the warning overlay images, and the continuous dynamic overlay images temporarily stored in each of the plurality of buffers.

11. The method as set forth in claim 7, wherein step (D) includes:
(D1) blending the decoded static overlay images, warning overlay images, and continuous dynamic overlay images, respectively;
(D2) overlaying and combining the blended static overlay images, warning overlay images, and continuous dynamic overlay images, respectively; and
(D3) displaying the overlaid and combined images by the overlay on a display unit.
